(19) United States
(12) Patent Application Publication
(10) Pub. No.: US 2009/0090257 A1
(43) Pub. Date: Apr. 9, 2009

(54) Combined stencil and digital printing system

(75) Inventors: Alon Feldman, Moshav Galia (IL); Ofer Ben-Zur, RaAnana (IL)

Correspondence Address: KEVIN O'NEILL, 6539 CORINTIA ST., CARLSBAD, CA, 92009, US

(73) Assignee: Kornit Digital Ltd., mOSHAV mAGSHIMIN (IL)

(21) Appl. No.: 11/919,947

(22) PCT Filed: May 7, 2006
(86) PCT No.: PCT/IL2006/000526

§ 371 Date: Nov. 6, 2007

(51) Int. Cl. B41L 13/00

(52) U.S. Cl. 101/114

(57) ABSTRACT

A carousel and station-based printing system for textiles comprises one or more stations with a digital printing apparatus and optionally other stations with a stencil printing apparatus. The system allows for high speed printing of images having details of high resolution, rich colors, or variability, optionally also comprising a wetting apparatus operative to wet at least a part of the printed object prior to the digital printing.

### FIELD AND BACKGROUND OF THE INVENTION

The present invention relates to printing and, more particularly, but not exclusively to the combination of stencil and digital printing.

Stencil printing and digital printing are both known methods in the art of printing. For printing a color image, the first step is color separation, where the image is separated into two or more “primary colors”.

In stencil printing, each color requires a separate stencil, which is fabricated prior to the actual printing. At the printing stage each stencil is coated with its respective color and pressed onto the printed material, as with offset printing, or the color is pressed through the stencil and onto the printed material, as with screen-printing. In a simple stencil printing all the sheets are first printed with one color, then the stencil is replaced and all the sheets are printed with a second color, etc. To achieve high speed and high efficiency, a modern stencil-printing machine has several stations, each station prints one color, and the printed sheets are moved in a sequence from station to station.

Digital printing employs a printing head having several ink injectors, each injector applying one color. A controller moves the printing head over the printed sheet (or the printed sheet under the printing head) and instructs the ink injectors when to inject ink. To speed up the printing process, a digital printing system may employ several printing heads concurrently, and a printing head may have hundreds injectors of the same color.

There are several methods of stencil printing and several methods of digital printing. For simplicity, screen-printing will represent stencil printing and inkjet printing will represent digital printing. Both stencil printing and digital printing have their advantages and disadvantage.

The fabrication of the stencils and the setup of the printing machine, e.g. the mounting of the stencils, is lengthy and expensive. However, the printing itself is fast and inexpensive. Stencil printing is therefore adequate for large product quantities. Stencil printing can easily employ special colors and special effects such as glittering particles. Digital printing creates images of higher spatial resolution (i.e. smaller pixel size) and higher color resolution (i.e. many more shades) of each color. The result is an image of much higher quality. Digital printing requires very short preparations prior to printing and is therefore advantageous for short run productions.

There is therefore a clear advantage in an effective combination of both methods. For example:
Printing large areas of the image using stencil printing and printing selected, small, strategic parts of the image, for example the eyes and their vicinity in a portrait, using digital printing.
Printing large areas of the image using stencil printing and printing selected, small, variable parts of the image, for example names and logos, using digital printing.

There is thus a widely recognized need for, and it would be highly advantageous to have, a printing system devoid of the above limitations.

### SUMMARY OF THE INVENTION

According to one embodiment of the present invention there is provided a printing system for printing on a surface including a stencil printing system and a digital printing system.

According to another embodiment of the present invention there is provided a printing system the digital printing system includes a printing head controllably mounted for printing onto selected locations of said surface.

Also according to the invention, the stencil printing system includes a plurality of printing stations and the digital printing system is incorporated into the stencil printing system as one of the printing stations.

Further according to the invention, the stencil printing system is incorporated into the digital printing system as an additional printing head.

Still further according to the invention, the printing system also includes a pre-printing wetting system.

Additionally according to the invention, the wetting system comprises a wetting head controllably mounted for wetting at least part of the selected locations prior to printing.

Also according to the invention, the wetting system applies a wetting composition capable of interfering with the engagement of a liquid ink composition with at least one binding site of the surface.

There is also provided, according to the present invention, a pre-printing wetting system.

Also according to the invention, the pre-printing wetting system is incorporated into the stencil printing system as one of the printing stations.

Further according to the invention, the wetting system is incorporated into the digital printing system as an additional printing head.

Still further according to the invention, the wetting system is incorporated into the printing station hosting the digital printing system.

Additionally according to the invention, the printing system is configured such that when the stencil printing creates an image over an area of the surface, the digital printing system applies ink onto the area before the stencil image is cured.

Also according to the invention, the printing system is configured such that when the stencil printing creates an image over an area of the surface, the wetting system applies the wetting composition onto at least a part of same the area before the stencil image is cured, and the digital printing system applies ink onto at least a part of same the wetted area before the wetting composition is cured.

Further according to the invention, the printing system is configured such that the stencil printing creates an image over an area of the surface and the digital printing system applies ink onto a different area of the surface.

Still further according to the invention, the printing system is configured such that the stencil printing creates an image of a first resolution and the digital printing system creates an image of a second resolution.

Additionally according to the invention, the stencil printing employs a first set of colors and the digital printing system employs a second set of colors, the second set of colors at least partially different from the first set of colors.

There is also provided, according to the present invention a printing system for printing on a surface including a stencil printing system and a digital printing system including at least one printing apparatus including at least one ink applicator operative to print an image over at least a part of the surface and at least one wetting apparatus including at least one liquid applicator operative to apply a wetting composition over at least a portion of the part of the surface prior to printing, the wetting composition being capable of interfering with the engagement of a liquid ink composition with at least one binding site of the surface.

Also according to the invention the stencil printing system is a screen printing system.

Further according to the invention the digital printing system comprises at least one of a spraying nozzle, a dripping nozzle, a droplet injector, a drop-on-demand piezoelectric inkjet nozzle, and a continuous piezoelectric inkjet nozzle.

There is also provided, according to the present invention, a digital printing system for printing on a surface, operative for incorporation into a stencil printing system, including a printing head controllably mounted for printing onto selected locations of the surface.

Also according to the invention the digital printing system also includes a wetting system operative to selectively apply wetting composition onto the surface, the wetting composition being capable of interfering with the engagement of a liquid ink composition with at least one binding site of the surface.

Further according to the invention the stencil printing creates an image over an area of the surface and the digital printing system applies ink onto the area before the stencil image is cured.

Also according to the invention the stencil printing is configured to create an image over an area of the surface and the digital printing system is configured to apply ink onto a different area of the surface.

There is also provided, according to the present invention, a digital printing system for printing on a surface, operative for incorporation into a stencil printing system, the digital printing system including at least one printing apparatus including at least one ink applicator operative to print an image over at least a part of the surface and at least one wetting apparatus including at least one liquid applicator operative to apply a wetting composition over at least a portion of the part of the surface prior to printing, the wetting composition being capable of interfering with the engagement of a liquid ink composition with at least one binding site of the surface.

There is further provided, according to the present invention, a printing apparatus for printing on a surface including a stencil printing apparatus and a digital printing apparatus.

There is still further provided, according to the present invention, a printing apparatus for printing on a surface including a stencil printing apparatus and a digital printing apparatus including at least one printing apparatus including at least one ink applicator operative to print an image over at least a part of the surface and at least one wetting apparatus including at least one liquid applicator operative to apply a wetting composition over at least a portion of the part of the surface prior to printing, the wetting composition being capable of interfering with the engagement of a liquid ink composition with at least one binding site of the surface.

There is additionally provided, according to the present invention, a digital printing apparatus for printing on a surface, operative for incorporation into a stencil printing apparatus, including a printing head controllably mounted for printing onto selected locations of the surface.

There is also provided, according to the present invention, a pre-printing wetting apparatus operative for incorporation into a stencil printing apparatus, the wetting apparatus operative to selectively apply wetting composition onto the surface, the wetting composition being capable of interfering with the engagement of a liquid ink composition with at least one binding site of the surface.

There is further provided, according to the present invention, a digital printing apparatus for printing on a surface, operative for incorporation into a stencil printing apparatus, the digital printing apparatus including at least one printing apparatus including at least one ink applicator operative to print an image over at least a part of the surface and at least one wetting apparatus including at least one liquid applicator operative to apply a wetting composition over at least a portion of the part of the surface prior to printing, the wetting composition being capable of interfering with the engagement of a liquid ink composition with at least one binding site of the surface.

There is additionally provided, according to the present invention, a printing apparatus for printing on a surface, including a stencil printing apparatus and a digital printing apparatus, wherein the surface is selected from the group consisting of a textile fabric, a plastic, a metal, a wood and a rock.

There is also provided, according to the present invention, a printing apparatus for printing on a surface, including a stencil printing apparatus and a digital printing apparatus, wherein the textile fabric is selected from the group consisting of wool, silk, cotton, linen, hemp, ramie, jute, acetate fabric, acrylic fabric, lastex, nylon, polyester, rayon, viscose, spandex, metallic composite, carbon or carbonized composite, and any combination thereof.

There is further provided, according to the present invention, a printing apparatus for printing on a surface, including a stencil printing apparatus and a digital printing apparatus, wherein the surface is a garment made of a textile fabric.

There is also further provided, according to the present invention, a printing apparatus for printing on a surface, including a stencil printing apparatus and a digital printing apparatus, wherein the textile fabric is selected from the group consisting of wool, silk, cotton, linen, hemp, ramie, jute, acetate fabric, acrylic fabric, lastex, nylon, polyester, rayon, viscose, spandex, metallic composite, carbon or carbonized composite, and any combination thereof.

There is additionally provided, according to the present invention, a printing apparatus for printing on a surface, including a stencil printing apparatus and a digital printing apparatus, wherein the textile fabric comprises cotton.

There is also provided, according to the present invention, a printing apparatus for printing on a surface, including a stencil printing apparatus, a digital printing apparatus a wetting apparatus, wherein the surface comprises of at least one of fibrous material, porous material, material having a high surface tension with the liquid ink.

There is further provided, according to the present invention, a pre-printing wetting apparatus for preparing a surface for printing, wherein the surface comprises of at least one of fibrous material, porous material, material having a high surface tension with the liquid ink.

Also according to a preferred embodiment of the present invention the wetting apparatus is a digital-printing apparatus.

Further according to a preferred embodiment of the present invention the wetting apparatus is a stencil-printing apparatus.

Still further according to a preferred embodiment of the present invention the wetting apparatus is a station within a multi-station stencil-printing apparatus.

Even further according to a preferred embodiment of the present invention the wetting apparatus is a screen-printing apparatus.

Additionally according to a preferred embodiment of the present invention the wetting composition includes screen-printing ink.

There is further provided, according to the present invention, a printing apparatus including a plurality of print stations and a carousel. Wherein the print stations are arranged about a circumference and operative for applying printing to a medium. Wherein the carousel is operative to carry the media and to rotate it about the circumference and between the print stations. And wherein at least one of the print stations is a stencil-type printing station and at least another one of the print stations is a digital-type printing station.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified schematic drawing of a garment printing apparatus comprising a stencil-printing apparatus and a digital-printing apparatus;

FIG. 1B is a simplified schematic drawing of a garment printing apparatus of FIG. 1A, additionally comprising a wetting apparatus;

FIG. 2 is a simplified perspective drawing of a garment printing apparatus comprising a multi-station stencil-printing apparatus and a digital-printing apparatus;

FIG. 3A and FIG. 3B, are, respectively, simplified top and side drawings of the garment printing apparatus of FIG. 1;

FIG. 4 is a simplified perspective drawing of the carousel-based garment printing apparatus constructed in accordance with one embodiment of the present invention.

FIG. 5 is a simplified perspective drawing of a more detailed view of the digital-printing apparatus of the garment printing apparatus of FIG. 1;

FIG. 6 is a simplified perspective drawing of a more detailed view of the printing head of the digital-printing apparatus of FIG. 3B;

FIG. 7 is a simplified perspective drawing of another embodiment of a garment printing apparatus comprising a stencil-printing apparatus, a wetting apparatus and a digital-printing apparatus;

FIG. 8 is a simplified flow chart of the process of wetting the garment prior to printing, preferably executed by a computer controlling the operation of the digital printing apparatus;

FIG. 9 is a schematic illustration of a wetting assembly preferably incorporated in the wetting apparatus incorporated in FIG. 6;

FIG. 10 is a perspective drawing of a battery of spraying nozzles preferably used by the wetting apparatus of FIG. 7;

FIG. 11 is a simplified perspective drawing of a preferred embodiment of a part of a wetting apparatus in accordance with the wetting apparatus of FIGS. 6, 7 and 9;

FIG. 12 is a simplified perspective drawing of a digital wetting and printing apparatus, which is a combination of the digital-printing apparatus 12 of FIG. 3B and the wetting assembly of FIG. 7, constructed and operative in accordance with another preferred embodiment of the garment printing apparatus;

FIG. 13 is a simplified flow chart of the process of wetting the garment prior to printing;

FIGS. 14, 15A and FIG. 15B are simplified perspective drawings of a preferred embodiment of the battery of FIG. 8 equipped with a bath, constructed and operative in accordance with one embodiment of the present invention.

FIG. 16 is a simplified perspective drawing of a garment printing apparatus constructed and operative in accordance with another preferred embodiment of the present invention.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention relates to a printing system that comprises a combination of a stencil-printing and a digital-printing, or pixel printing. A preferred embodiment of the present invention also comprises a wetting apparatus that is useful for printing over materials that usually cause the ink to smear over the material, such as fibrous materials, porous materials and other ink absorbing materials, and materials having high surface tension with the ink liquid. A preferred embodiment of the present invention is thus provided for the garment industry in general, and for T-shirt printing industry in particular, as will be shown and described below.

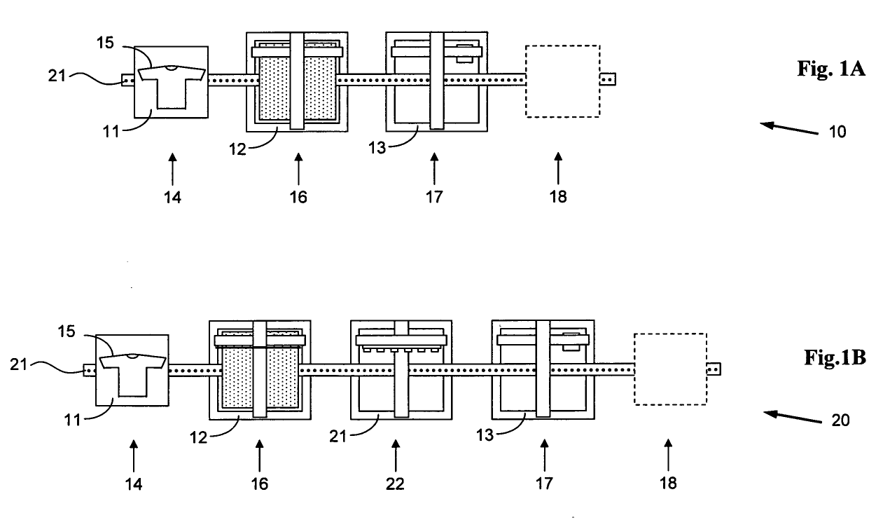

Reference is now made to FIGS. 1A and 1B, which are simplified schematic drawings of two preferred embodiments of the present invention. FIG. 1A shows a garment printing apparatus 10 comprising a printing table 11, a screen printing apparatus 12 and a digital printing apparatus 13 configured in four stations: garment loading station 14 for loading the garment 15, screen printing station 16, digital printing station 17 and unloading station 18. The printing head 10 is movable on a conveyor 19 FIG. 1B shows a garment printing system 20 another preferred embodiment of the present invention, additionally comprising a wetting apparatus 21 within a wetting station 22.

The combination of stencil-printing and digital-printing provides the following benefits:
Stencil-printing is used to print large areas and rich coloring, while digital-printing is used to print small details in high spatial resolution and more shades of gray.
Stencil-printing is used to print large areas, while digital-printing is used to add smaller varying details such as names and logos.
Stencil-printing is used to print large dark background, or white background over dark material, while digital-printing is used to print varying details in short runs.
Stencil-printing is used to special colors and special effects, such as glittering particles, while digital-printing is used to print a high quality image.

It is appreciated that the above benefits are but few preferred examples and that any other combination of the features of stencil printing and digital printing may be useful.

It is appreciated that typically the stencil-printing is performed before the digital-printing, however, it is possible to perform the digital-printing first and then the stencil-printing.

The printing system of the present invention preferably comprises the following processes performed sequentially:

Pre-Printing

These steps are performed once for each image and for all the garments of a production run:
Defining the areas to be printed by the stencil-printing technology, by the digital-printing technology, or both;
Separating the colors of each component into the sets of colors used by the adequate printing technology;
Optionally defining the areas to be wetted;
Mounting the stencils into the stencil-printing apparatus and loading the digital image into the digital printer; and
Registration of the stencils and the digital-printing.

Printing

These steps are performed repetitively for each garment in a production run:
Loading a garment;
Printing an image, using stencil-printing technology, over at least a part of the mounted garment. This process preferably comprises several steps of using several stencils;
Optionally wetting at least a part of the area of the garment to be printed using digital-printing technology;
Printing an image, using digital-printing technology, over at least a part of the mounted garment, optionally over at least a part of the wetted area; and
Unloading a garment.

In the registration step all the stencils and the digital printing head are aligned so that all the components of the image are located at their appropriate place. A preferred method of registration of the stencils is by manually aligning cross marks in the four corners of each of the stencils. Preferably, the digital printing head is then brought to at least two opposite cross marks, with the aid of a needle pointer, or, alternatively, with the aid of a laser pointer. Further alternatively, the digital printer is used first to print the cross marks and all the stencils are aligned accordingly.

In order to increase the throughput of the system during the printing phase, the printing system preferably comprises a plurality of stations and the printing processes are preferably performed in parallel, each in a different station. Preferably the processes are performed each in a different station, in parallel, for a different piece of garment, so that each piece of garment undergoes all the processes sequentially.

The present embodiments have at least one of the following preferred configurations, however, additional configurations may also exist:
A digital-printing apparatus incorporated into at least one station of a stencil-printing apparatus not comprising a wetting apparatus and not performing the wetting process;
A wetting apparatus incorporated into a digital-printing apparatus that is incorporated into at least one station of a stencil-printing apparatus;
A digital-printing apparatus incorporated into at least one station of a stencil-printing apparatus and an independent wetting apparatus incorporated into a different station of the stencil-printing apparatus;
A stencil-printing apparatus incorporated into a digital-printing apparatus not comprising a wetting apparatus and not performing the wetting process;
A stencil-printing apparatus incorporated into a digital-printing apparatus comprising a wetting apparatus.

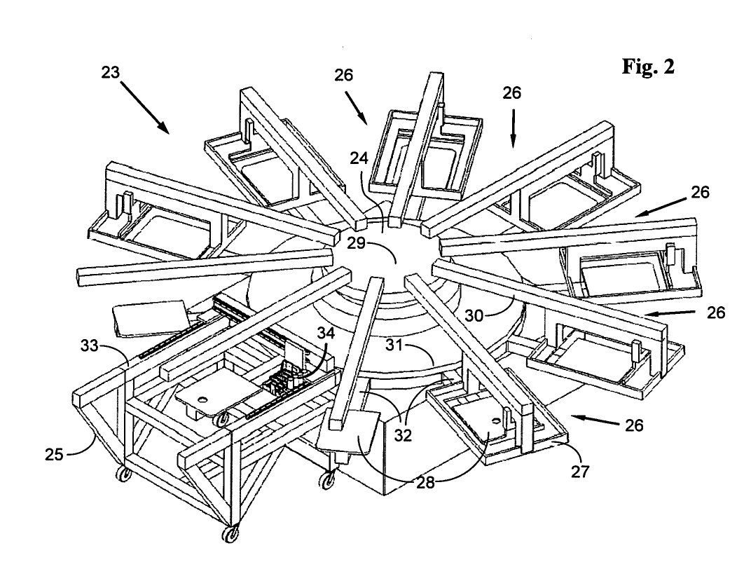

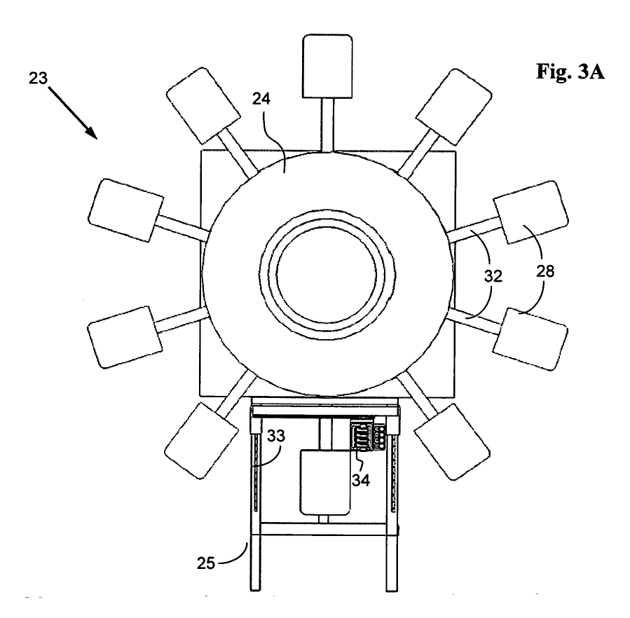

Reference is now made to FIG. 2, which is a simplified perspective drawing of a garment printing apparatus 23 constructed and operative in accordance with one embodiment of the present invention. The garment printing apparatus 23 comprises a stencil-printing apparatus 24 and a digital-printing apparatus 25. The stencil-printing apparatus 24 preferably comprises several stations 26, preferably arranged in a carousel configuration. The stencil-printing apparatus 24 preferably comprises two parts: one that is fixed and preferably comprises at least one stencil-printing head 27, and another part that is rotating and preferably comprises at least one printing table 28. In a preferred embodiment of the present invention the fixed part comprises a fixed central structure 29, on which several upper beams 30 are radially mounted, and a stencil-printing head 27 is mounted on each beam. The moving part comprises a rotating central structure 31, on which several lower beams 32 are radially mounted, and a printing table 28 is mounted on each beam.

Preferably one of the stations is used to mount objects to be printed on the rotating printing tables 28 prior to printing and to remove them after printing. Preferably, to enable faster printing, two stations are used, one for mounting and the other for removing the objects to be printed. Preferably, in accordance with one embodiment of the present invention, the stencil-printing apparatus 24 of FIG. 2 is a Synchropoint 3000 screen printing machine model SP10 from MHM Siebdrukmaschinen Gmbh KG of Muehlgraben 43a, A-6343 ERL, Austria, having 10 stations.

It is appreciated that the carousel configuration is not a limiting factor and that the stations can be arranged in any other topology. It is also appreciated that the printing tables 28 may be fixed and the stencil-printing head 27 may be moving. It is further appreciated that the number of stations can be any number. It is additionally appreciated that any stencil-printing technology can be adapted for the purpose of the present invention and not just the screen printing technology described herein.

As can be seen in FIG. 2, at least one of the stations 26 of the printing machine 23 hosts the digital-printing apparatus 25. The digital-printing apparatus 25 comprises a frame 33 that is arranged to allow the carousel of lower beams 32 and printing tables 28 to rotate through the frame 33 and under a digital-printing head 34.

Preferably the station hosting the digital-printing apparatus 25 is the last but one station, just before the station where the printed objects are removed from the printing tables 28. It is appreciated that any station can host the digital-printing apparatus 25. It is further appreciated that the printing machine 23 can comprise several digital-printing apparatus 25, preferably each digital-printing apparatus 25 is hosted in a separate station 26.

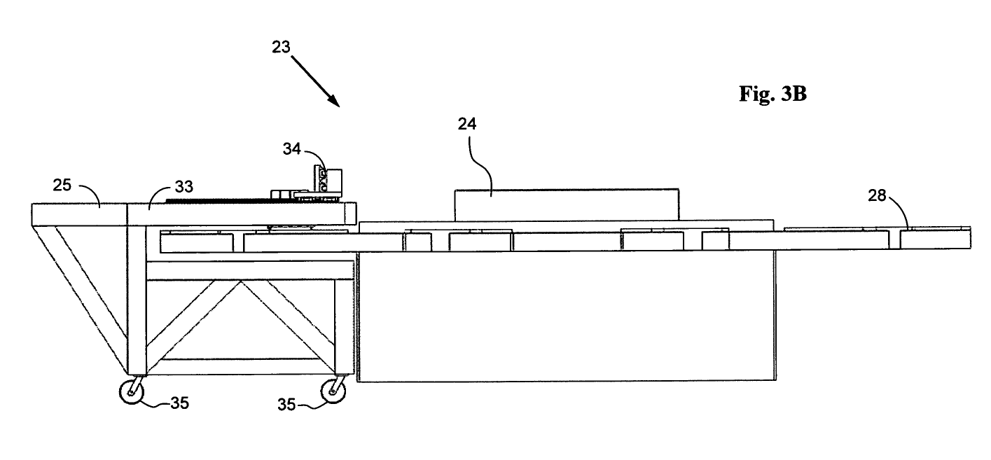

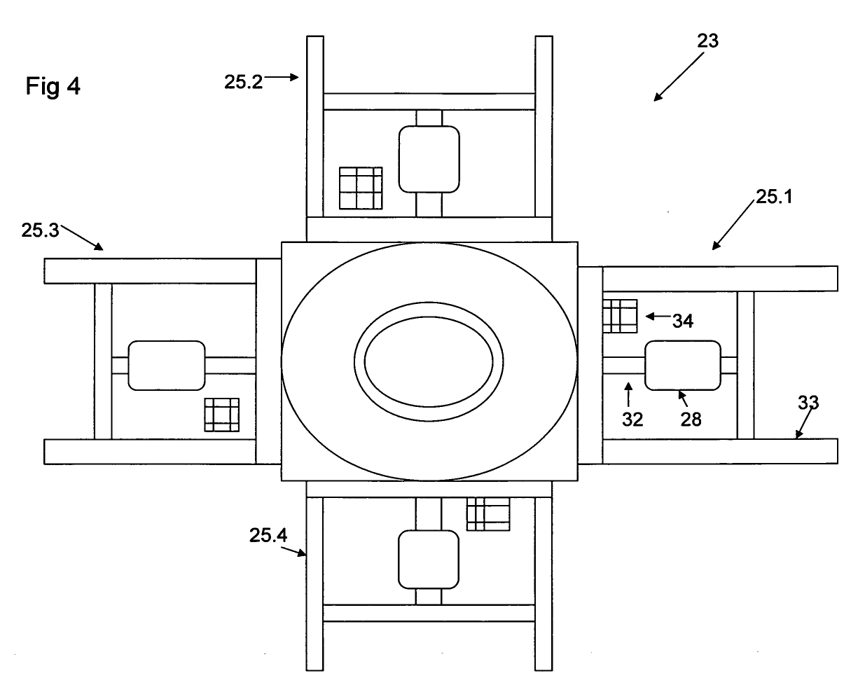

Reference is now made to FIG. 3A and FIG. 3B, which are, respectively, simplified top and side drawings of the garment printing apparatus 23 of FIG. 2. For clarity, the fixed part of the stencil-printing apparatus 24 is not shown. As can be seen in FIGS. 3A and 3B, the frame 33 of the digital-printing apparatus 25 is disconnected from the stencil-printing apparatus 24 and is mobile, preferably on wheels 35, to enable hosting in any station 26 of any stencil-printing apparatus 24. Thus, preferably, the configuration of the printing apparatus 23 can be optimized to the printing requirements of each object to be printed, on the manufacturing floor. As can be seen in FIGS. 3A and 3B, the digital-printing apparatus 25 allows the lower beams 32 and their printing tables 28 to rotate through the frame 33 and under the printing head 34. It is appreciated that alternatively the printing head 34 can be mounted from an upper beam 30 of the stencil printing system 24 (not shown in FIGS. 3A and 3B).

Reference is now made to FIG. 4, which is a simplified perspective drawing of the carousel-based printing machine constructed in accordance with one embodiment of the present invention. In FIG. 4. each of the stations 26 of the printing machine 23 host a digital printing apparatus 25. In the figure, the carousel has four stations, 25.1-25.4, but the number of stations may vary. As explained above, the digital printing apparatus 25 comprises a frame structure 33 that is arranged to allow lower beams 32 and printing table 28 on the carousel to rotate through frame 33 and under digital print head 34. It is appreciated that the above description of the digital printing apparatus applies to each apparatus at each station.

The printing machine may use exclusively digital printing at all the stations for a variety of reasons. The digital printing task may demand high resolution or more shades of gray or color, and digital printing can give a higher resolution and provide more color shades more easily than a stencil type apparatus. Another reason to employ exclusively digital stations is that the digital systems allow for easier setup. It will be appreciated that any combination of digital and other kinds of print stations is contemplated, depending on the textile printing tasks expected.

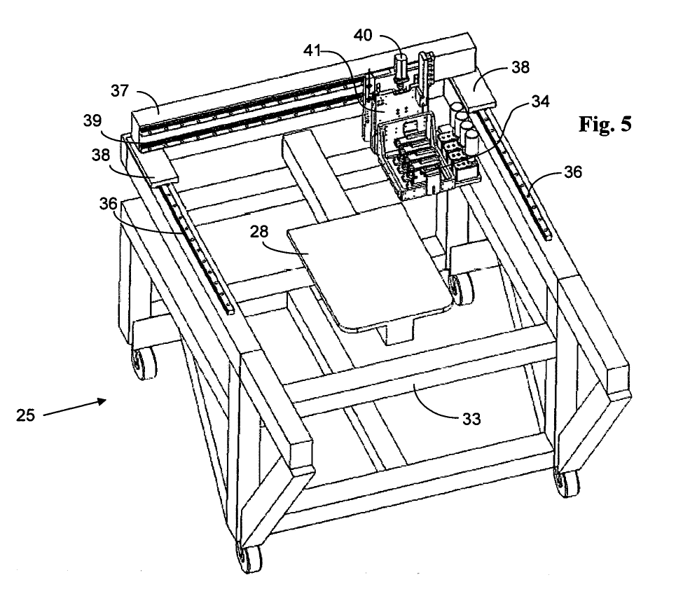

Reference is now made to FIG. 5, which is a simplified perspective drawing of a more detailed view of the digital-printing apparatus 25 of the printing system 23 constructed and operative in accordance with one embodiment of the present invention. As can be seen in FIG. 5, the digital-printing apparatus 25 comprises:
the rigid frame 33;
an accurate linear motion, preferably dual, X-axis stage 36 mounted over the rigid frame 33;
a bridge 37, mounted perpendicular to the dual X-axis 36, on two moving plates 38 supported on the X-axis rails;
an accurate linear motion Y-axis stage 39 mounted on the bridge 37;
optionally, an accurate linear motion Z-axis stage 40 mounted vertically, on a moving plate 41, mounted on the Y-axis stage 39; and

The printing head 34 mounted either on the moving plate 41 or, optionally, on the Z-axis stage 40.

The X-axis 36, the Y-axis 39 and the Z-axis 40 stages are known in the art as linear stages, preferably capable of high acceleration rate and stiffness, such as rails marketed by THK Co., Ltd., Tokyo, Japan or Anorad brand model LW10 of Rockwell Automation, Shirley, N.Y., USA., or a ball screw driven stage.

The gap between the printing head 34 and the printed surface on the printing table 28 is an important parameter for high quality printing. The Z-axis stage 40, which is preferably a ball screw driven stage, enables movement of the printing heads array 34 in the vertical direction for calibration for different media heights.

The position of the printing head 34 along the rails of the X-axis stage 36, the Y-axis 39 and the Z-axis 40 are preferably measured by a linear encoders, such as linear encoders sold by RSF Elektronik Ges.m.b.H., Tarsdorf, Austria. A closed loop control is responsible for the high accuracy and motion smoothness and is used also to determine the firing timing of the inkjet nozzles and the wetting nozzles.

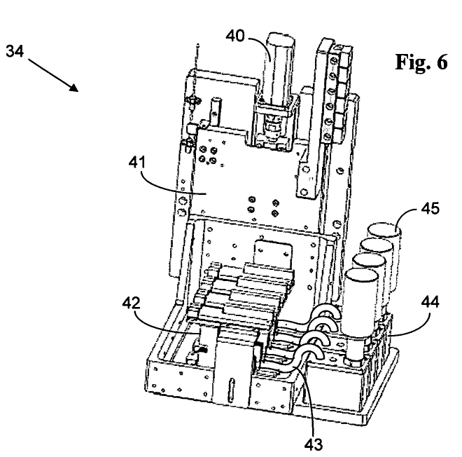

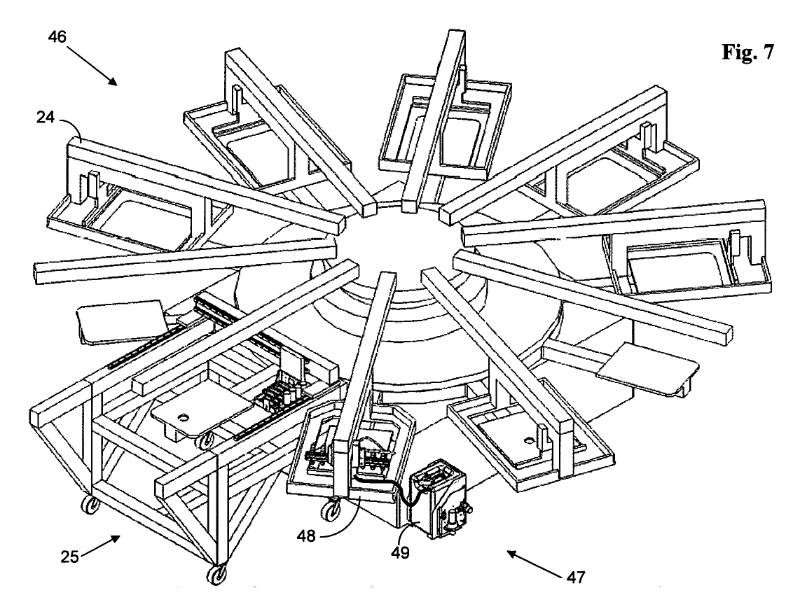

Reference is now made to FIG. 6, which is a simplified perspective drawing of a more detailed view of the printing head 34 of the digital-printing apparatus 25 of the printing system 23 constructed and operative in accordance with one embodiment of the present invention. As can be seen the printing head 34 preferably comprises a plurality of inkjet nozzles 42, each connected by a pipe 43 to an ink reservoir 44 and removable ink container 45.

It is appreciated that any other ink applying apparatus can be used for the printing head 34, such as a dripping nozzle, a droplet injector, a drop-on-demand piezoelectric inkjet nozzle, a continuous piezoelectric inkjet nozzle, a roller pad, an offset printing stencil and a screen printing stencil.

It is also appreciated that, while the system is particularly suited for printing on a finished garment, other media can alternatively be employed. The present invention will be described with regard to a finished garment, for ease of description by way of example.

It is further appreciated that if the duration of the digital-printing is much longer than the duration of a single stencil-printing and therefore considerably slows the rotation of the carousel, it is possible use two or more digital-printing apparatus 25. Preferably the digital-printing apparatus are hosted in separate, preferably the last, stations of the stencil-printing apparatus 24. The image to be printed digitally is divided into two, or more, parts, and each part is printed by a different digital-printing apparatus 25.

One of the key limitations in the process of applying a liquid ink on absorptive surfaces, such as those made of fibrous materials or porous materials, stems from the interaction of the liquid ink with the material once the ink is applied, and before the ink is fully cured and fastened to the fabric. As is well known to a skilled artisan, when ink droplets are absorbed into an absorptive material upon contacting the surface, the color dots begin to feather (bleed), spread out in an irregular fashion, and therefore cover a larger area than the intended area, thus producing a fuzzy image with dull colors and low definition. Hence, while the quality of the printed image depends on the degree of absorption of the ink in the material of the subject surface, it is well recognized that in order to achieve a high-resolution and high-definition multicolor image on absorptive surfaces (obtained, for example, by spraying the inks onto the fabric's surface), it is highly desirable that an applied ink droplet would stay as a tight, symmetrical dot once being in contact with the fabric, and until it is fully cured.

The presently known printing technologies are also limited when applied on other absorptive surfaces, as well as surfaces that are characterized by high surface tension and glossy finish. In the latter type of surfaces, the ink droplets tends to expand and over-spread due to physical interactions adverse to the printing process, thus leading to reduced resolution of the printed image.

In a search for a comprehensive and efficient solution for the limitations associated with printing on absorptive surface, such as a textile fabric, as well as other problematic surfaces as described hereinabove, the present inventors have envisioned that the quality of a printed image could be enhanced by temporarily modifying the physical, chemical and/or mechanical characteristics of the surface. Thus, while conceiving the present invention, it was hypothesized that such a modification could be achieved by contacting the surface with an agent that would temporarily modify these characteristics of the surface such that the engagement of the ink with the binding sites of surface would be decreased. It was further hypothesized that such an agent can be comprised of simple, available organic composition and thus it was further envisioned that such a methodology would result, in addition to the improved quality of the image, in a cost-effective process, and in a printed surface with no adverse characteristics such as unpleasant feel.

Contacting a textile surface with variable wetting compositions, prior to applying the ink thereon, renders the surface of the textile fabric temporarily less absorptive to the ink, such that the dots of the ink do not feather or bleed until the ink is fully applied and further cured on the surface, thereby affording a sharp, highly defined and vivid image. Hence, according to at least one embodiment of the present invention the process of printing an image on a surface is effected by wetting at least a part of the surface with a wetting composition; and applying a liquid ink composition on the wet part of the surface, so as to form an image thereon.

The wetting composition is selected capable of interfering with the engagement of the liquid ink composition with at least one binding site of the surface. Such an interference includes, for example, temporarily modifying a mechanical property of the surface by, for example, reducing the contact area between the ink composition and the surface by, e.g., filling the pores in the surface or flattening perturbing objects such as stray fibers; temporarily modifying a physical property of the surface by, for example, reducing the surface tension formed between the surface and the ink composition; and temporarily modifying a chemical property of the surface by, for example, engaging the binding sites of the surface by, e.g., interacting with functional groups on the surface, masking, neutralizing or inverting the charge of functional groups on the surface.

As used herein the phrase “binding site” describes any site of the surface that may interact, either chemically, mechanically or physically, with the ink composition. These include, for example, functional groups on the surface that may chemically bind compatible functional groups present in the ink composition; functional groups on the surface that may form hydrophobic or hydrophilic interactions with compatible functional groups present in the ink composition; flattening perturbing objects such as stray fibers that can interfere with the uniform application of the ink composition on the surface; any dry area of the surface which may thermodynamically promote absorption of the liquid ink composition; and any area of the surface which due to too high or too low surface tension promotes minimization or maximization of surface area of the ink droplets on the surface.

Applying the liquid ink composition can be effected by any of the printing techniques known in the art, including, but not limited to, ink-jet printing, screen printing, printing block (mold) techniques, dye sublimation techniques and the likes.

As used herein, the phrase “at least a part of the surface” describes one or more areas of the surface, and includes also the entire surface. Preferably the part of the surface that is contacted with the wetting composition includes the area onto which the ink is later on applied, namely, the total area covered by the printed image. The areas may be continuous or discontinuous.

Hereinunder in this section, the term “surface” is used to describe any area of the surface, including specific parts of the surface, as described above.

The printing process may further include, subsequent to the formation of the image, curing the image. The curing can be effected by heat and/or dry air emanating from a heat source such as, for example, an infrared conveyor or a filament coil, or a dry air source such as, for example, a hot air blower.

Contacting the surface with the wetting composition, according to the process of the present invention, may be performed by any method or technique for applying a liquid onto an object, including, but not limited to, spraying, ejecting, smearing, spreading, brushing, dipping, dripping, impregnating, pouring, condensing, scattering, dispersing, dissipating, dissolving, melting, or a combination of some of these wetting methods. Alternatively, contacting the surface with the wetting composition can be effected by converting a composition to a liquid form on an object, e.g., by condensation of a vaporized liquid onto the surface or melting a solidified liquid onto the surface. A suitable method is selected so as to comply with the physical properties of a specific wetting composition, and to comply with a given printing machine and technology.

According to a preferred embodiment of the present invention, contacting the surface with the wetting composition is effected by spraying, ejecting or dripping the wetting composition onto the desired part of the surface, by means of a liquid applicator. These methods are most suitable for a controlled and automatic in-line wetting procedure, and can therefore be easily implemented as a part of many mechanized printing techniques.

Contacting the surface with the wetting composition can be further controlled by pre-determining the area of the surface that is to be wetted by the wetting composition, so as to contact with the wetting composition only that specific, pre-determined area of the surface onto which the image is printed in the subsequent stage of the process. The pre-determination of the area to be wetted allows for optimization of the entire printing process which depends on accurate material quantification, i.e., of the wetting and the ink compositions, and accurate timing of each printing steps, i.e., the wetting, the ink application and the curing steps. The pre-determination of the area of the surface can by readily established by a computerized algorithm. Hence, according to a preferred embodiment of the present invention, the part of the surface that is contacted with the wetting composition is pre-determined digitally.

The amount of the wetting composition applied on the surface during the contacting described above can be controlled by the liquid applicator mechanism. A suitable amount would be an amount that ensures uniform and adequate coverage of the surface with the wetting composition and further which ensures efficient modification of the surface physical characteristics regarding the engagement of the ink with the binding sites of the surface material.

Preferably, contacting the surface with the wetting composition is performed so as to obtain a wet part of the surface in which the density of the wetting composition ranges from about 0.01 gram per 1 cm² of the surface to about 2 grams per 1 cm² of the surface, more preferably from about 0.05 gram per 1 cm² to about 1 gram per 1 cm², more preferably from about 0.1 gram per 1 cm² to about 1 gram per 1 cm² and, more preferably, from about 0.2 grams per 1 cm² to about 0.6 grams per 1 cm².

As used herein the term “about” refers to ±10%.

Hence, without being bound to any particular theory, it is assumed that contacting the surface with a wetting composition renders the resulting wet surface temporarily less absorptive to the ink by reducing its surface tension. More specifically, it is assumed that the interference with the engagement of the ink composition with the surface is at least partially affected by reducing the surface tension of the surface. Thus, it is assumed that a wetting composition characterized by a low surface tension in general, and particularly with respect to the liquid ink composition may interfere with the absorption of the ink into an absorptive surface such as a textile fabric. Therefore, it is assumed that preferred wetting compositions according to the present invention are those that exhibit the required surface tension difference between a given liquid ink composition and the wetting composition.

The phrase “surface tension” as used herein, refers to the phenomena exhibited when two fluids become in contact, stemming from the difference in the molecular attraction forces of the molecules in each liquid, which reveals itself at in the interface between the liquids. The surface tension is a result of the unbalanced force experienced by molecules at the surface of a liquid. As a result of surface tension, a drop of liquid tends to form a sphere, because a sphere offers the smallest area for a definite volume. The higher the surface tension, the tighter the sphere will be, and vice versa, the lower the surface tension is, less is the tendency of the liquid to form a spherical droplet. Substances with low surface tension have a tendency to form films. For example, the force of adhesion between an aqueous liquid and a liquid hydrocarbon is very small compared to the force of cohesion between the water molecules in the aqueous liquid. As a result, water does not adhere to wax and tends to form spherical beads, or droplets, with the smallest possible surface area, thereby maximizing the force of cohesion between the water molecules. One method of measuring surface tension is by means of a capillary tube. If a liquid of density d rises a height h in a tube of internal radius r, the surface tension is equal to rhdg/2. The result will be in dynes per centimeter if r and h are in centimeter, d in grams per centimeter cube (cm³) and g in centimeter per second squared (sec²).

Hence, according to a preferred embodiment of the present invention, the wetting composition is characterized by a relatively low surface tension.

Preferably, the surface tension of the wetting composition is lower than 50 dynes per centimeter. Further preferably, the surface tension of the wetting composition ranges from about 35 dynes per centimeter to about 15 dynes per centimeter. More preferably, the surface tension of the wetting composition ranges from about 25 dynes per centimeter to about 10 dynes per centimeter.

According to another preferred embodiment of the present invention, the wetting composition and the liquid ink composition are selected such that the surface tension of the wetting composition is lower that the surface tension of the liquid ink composition. Preferably, the surface tension of the wetting composition is lower than the surface tension of the liquid ink composition by at least 2 dynes per centimeter, more preferably by at least 3 dynes per centimeter, more preferably by at least 5 dynes per centimeter and even more preferably by at least 10 dynes per centimeter.

According to a preferred embodiment of the present invention, the wetting composition includes one or more organic solvents.

Since, as is discussed hereinabove, the wetting composition is aimed at temporarily modify the mechanical, physical and chemical properties of the surface during the application of the ink thereon, while not affecting other properties of the surface, it is highly desirable that at least a majority the wetting composition could be removed from the surface once the printing process is completed. One of the simplest routes of removing substances under these conditions is by evaporation. Therefore, preferred organic solvents are characterized as volatile.

As used herein, the term “volatile” refers to a substance or a composition that is characterized by a relatively low boiling point and/or high evaporation rate.

As is well accepted in the art, boiling points below 100° C. are considered as relatively low boiling points. Hence, according to a preferred embodiment of the present invention, the organic solvent has a boiling point lower than 100° C. Such organic solvents can be easily removed once the printing process is completed, during, for example, the curing process, as described above, which involves application of heat or air blow onto the surface.

Preferred organic solvents according to this embodiment of the present invention are further characterized by an evaporation rate that is greater than 0.1, preferably greater than 0.2 and typically ranges between 0.1 and 5. As is well known in the art, values of evaporation rates of substances are determines with reference to the evaporation rate of butyl acetate, which is arbitrarily set as 1.

As is discussed hereinabove, since it is assumed that characteristics such as volatility and low surface tension improve the beneficial effect of the wetting composition, preferred organic solvents are those that exhibit such characteristics. Representative examples of such organic solvents include, without limitation, alkanes, alkenes, cycloalkanes, cycloalkanes and aryls, which are collectively referred to herein as hydrocarbons, alcohols, ketones, ethers, alkyl polysiloxanes, heteroalicyclics, heteroaryls and any combination thereof.

As used herein, the term “alcohol” describes a chemical substance that bears one or more hydroxyl groups. The term “hydroxyl” refers to a —OH group. An alcohol can be represented by R—OH, wherein R is alkyl, a cycloalkyl, alkenyl, alkynyl, aryl, heteroaryl and the likes, as these terms are defined hereinbelow. However, this term further encompasses such groups that bear two or more hydroxyl groups. Such substances are also referred to herein as polyols.

Non-limiting examples of alcohols that are suitable for use in the context of the present invention include methanol, ethanol, propanol, 2-propanol, 1-butanol, 2-butanol and pentanol. The presently most preferred alcohols are ethanol, 2-propanol (isopropyl alcohol, IPA) and 1-butanol.

Non-limiting examples of polyols that are suitable for use in the context of the present invention include ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thioglycol.

The term “ketone” describes a chemical substance that has one or more carbonyl groups. The term “carbonyl” as used herein, describes a —C(═O)—R′, thus a ketone can be represented by R—(C═O)—R′ wherein R is as define hereinabove, and R′ is as defined for R.

Non-limiting examples of ketones that are suitable for use in the context of the present invention include acetone, cyclopentanone, cyclohexanone, methyl ethyl ketone and pentan-3-one. The presently most preferred ketone is cyclohexanone.

The term “ether” describes a chemical substance having one or more alkoxy groups. The term “alkoxy” refers to an —OR group, wherein R is as described hereinabove, and thus an ether can be represented by R—O—R′, wherein R and R′ are each independently as define hereinabove.

Non-limiting examples of ethers that are suitable for use in the context of the present invention include ethylene glycol butyl ether acetate, propyl methyl ether, methoxy propanol, diethyl ether, 1-methoxyhexane, 1-ethoxyhexane and 1-propoxypentane. The presently most preferred ethers are ethylene glycol butyl ether acetate and propyl methyl ether.

The phrase “alkyl polysiloxanes” describes a polymeric chemical substance having the general formula

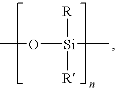

wherein n is an integer denoting the number of repeating polymeric units, and R and R′ are each independently as defined hereinabove. Preferably, n is an integer from 1 to 3.

Non-limiting examples of alkyl polysiloxanes that are suitable for use in the context of the present invention include dimethyl polysiloxane, ethyl methyl polysiloxane, phenyl methyl polysiloxane and nitrilobutyl phenyl polysiloxane. The most preferred alkyl polysiloxane is dimethyl polysiloxane.

The term “alkane” or “alkyl” describes a saturated aliphatic hydrocarbon including straight chain and branched chain groups. Preferably, the alkane has 6 to 20 carbon atoms. Whenever a numerical range; e.g., “6-20”, is stated herein, it implies that the group, in this case the alkane, may contain 6 carbon atom 2, 7 carbon atoms, 8 carbon atoms, etc., up to and including 20 carbon atoms. More preferably, the alkane is a medium size alkane having 6 to 14 carbon atoms. Most preferably, unless otherwise indicated, the alkane is a lower alkane having 6 to 10 carbon atoms. The alkane may be substituted or unsubstituted. Substituted alkanes may have one or more substituents, whereby each substituent can independently be, for example, halide, alkyl, cycloalkyl, alkenyl, alkynyl, aryl, heteroaryl and the likes.

The term “halide” group refers to fluorine, chlorine, bromine or iodine.

Non-limiting examples of alkanes that are suitable for use in the context of the present invention include hexane, heptane, octane, petroleum ether, tert-butylchloride, isobutylchloride, perfluorohexane, perfluoroheptane and perfluorooctane. The most preferred alkanes are petroleum ethers, heptane, octane and perfluorohexane.

The term “cycloalkane” or “cycloalkyl” refers to an all-carbon monocyclic or fused ring (i.e., rings which share an adjacent pair of carbon atoms) group where one or more of the rings does not have a completely conjugated pi-electron system. The cycloalkane may be substituted or unsubstituted. When substituted, the substituent group can be, for example, halide, alkyl, cycloalkyl, alkenyl, alkynyl, aryl, heteroaryl and the likes.

The term “aryl” refers to an all-carbon monocyclic or fused-ring polycyclic (i.e., rings which share adjacent pairs of carbon atoms) groups having a completely conjugated pi-electron system. The aryl group may be substituted or unsubstituted. When substituted, the substituent group can be, for example, halide, alkyl, cycloalkyl, alkenyl, alkynyl, aryl, heteroaryl and the likes. Representative examples of aryls are benzene, naphthalene, dichlorobenzene, xylene, cymene and 1-chloro-4-methylbenzene.

The term “heteroalicyclic” refers to a monocyclic or fused ring group having in the ring(s) one or more atoms such as nitrogen, oxygen and sulfur. The rings may also have one or more double bonds. However, the rings do not have a completely conjugated pi-electron system. The heteroalicyclic may be substituted or halide, alkyl, cycloalkyl, alkenyl, alkynyl, aryl, heteroaryl and the likes. Representative examples of heteroalicyclics are piperidine, piperazine, tetrahydrofurane, tetrahydropyrane, morpholino and the likes.

The term “heteroaryl” refers to a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted. When substituted, the substituent group can be, for example, halide, alkyl, cycloalkyl, alkenyl, alkynyl, aryl, heteroaryl and the likes. Representative examples of heteroaryls are pyridine, pyrrole, oxazole, indole, purine and the likes.

The presently most preferred wetting compositions according to the present invention include one or more of the alcohols and hydrocarbons described hereinabove.

The wetting composition may include, in addition to, or instead of, the organic solvent, water.

The wetting composition according to the present invention may optionally further include one or more agents that may additionally alter the interaction of the ink composition with the surface.

These agents include, for example, one or more adhesion promoting agents. As is well known in the art, adhesion promoting agents are typically comprised of one or more substantially saturated, predominantly or substantially hydrocarbon oligomers or polymers, containing reactive functional groups that are capable of reacting with a co-polymer or a cross-linking agent upon heat exertion, oxidation, drying and other chemical and physical conditions. By being cross-linked, the adhesion promoting agents typically form an adhesive film.

The addition of the adhesion promoting agent(s) to the wetting composition of the present invention beneficially affects the properties of the resulting image by stabilizing the colorants of the liquid ink compositions after the curing procedure, and thus improving the wash-fastness of the printed image. The addition of the adhesion promoting agents may optionally also improve the surface tension relations between the wetting composition and the ink composition.

Non-limiting example of adhesion-promoting agents that are suitable for use in the context of the present invention include various polymers and copolymers such as acrylic resins, polyurethane emulsions and resins, polyether resins, polyester resins, polyacrylate resins, polyvinyl chloride resins, polyvinyl acetate resins, polyvinyl butyral resins, aminosilicon resins and combinations thereof.

Additional agents that may be beneficially incorporated in the wetting of the present invention include, for example, one or more of viscosity modifying agents, thickening agents, rheology modifying agents, surface tension modifying agents, surface active agents, surfactants, softeners and combinations thereof. The addition of such agents to the wetting composition may improve the effect of the wetting composition and may further provide a selected wetting composition with desirable characteristics. Thus, for example, the addition of rheology modifying agents which improves the mechanical properties of the surface, may enable the application of a reduced amount of the wetting composition. The addition of surface tension modifying agents enables to use a wetting composition that comprises an organic solvent with moderate surface tension characteristics, which are improved by the added agent. The addition of viscosity modifying agents enables to use a wetting composition that comprises an organic solvent with high viscosity, which is reduced by the added agent, and so on.

Representative examples of agents that can be beneficially added to the wetting composition of the present invention include, without limitation, clays, polysaccharides, polyols such as propylene glycol and glycerin, modified siloxanes and polyalkylsiloxanes, aldehyde based liquid resins such as melamines, urea formaldehyde, phtalates, isocyanates, polymers and oligomers having hydroxyl, carboxyl or amide functional groups and catalysts, and thermally activated agents such as peroxides, epoxides, isocyanates and acrylates.

The agents described above can be incorporated in a wetting composition that comprises an organic solvent either per se, such that the final form of the wetting composition can be, for example, a mixture, a solution, an emulsion or a suspension, including these agents. Alternatively, these agents can be incorporated as an aqueous solution, suspension or emulsion, such that the resulting wetting composition comprises water.

The agents described above can be applied onto the surface as a part of the wetting composition (typically as a mixture, suspension or an emulsion that comprises one or more organic solvents as detailed hereinabove, one or more of these agents and optionally water), within the contacting of the surface with the composition. Alternatively, these agent(s) can be applied onto the surface prior to or subsequent to contacting the surface with the wetting composition. Further alternatively, a wetting composition that comprises one or more organic solvents can be applied on the surface during the contacting procedure and a wetting composition that comprises a mixture (e.g., an emulsion) of one or more organic solvent and one or more of these agents is applied prior or subsequent thereto.

Alternatively, or in addition to the above, the additional agent(s) can be applied onto the image, either per se or as a part of the wetting composition, subsequent to applying the ink composition. This procedure is aimed at protecting the image from wearing and loosing its definition, as discussed hereinabove.

The concentration of these agent(s) when added to the wetting composition according to the present invention preferably ranges from about 0.01 weight percentages to about 75 weight percentages of the total weight of the wetting composition, more preferably from about 0.5 weight percentages to about 15 weight percentages of the total weight of the wetting composition and more preferably from about 1 weight percentages to about 5 weight percentages of the total weight of the wetting composition.

Hence, according to a preferred embodiment, an exemplary wetting composition according to the present invention includes 95 weight percents ethanol and 5 weight percents of an acrylic emulsion (about 50% solids) and the process includes application such a composition prior and subsequent to the application of the ink composition. Applying this wetting composition prior to the ink application interfere with the engagement of the ink with the surface, and applying this wetting composition thereafter provides for improved color gamut, definition, brightness and wash-fastness of the printed image.

The printing process according to the present invention can be applied using a variety of liquid ink compositions typically used in printing techniques known in the art and therefore can be applied using aqueous-based ink compositions and non-aqueous solvent-based ink compositions.

Aqueous-based ink compositions typically contain deionized distilled water as a main carrier or solvent, and other carriers and coating chemicals such as, for example, cymel 323 (Cytec Industries).

Non-aqueous solvent-based liquid ink compositions typically contain an organic component as a main carrier or solvent. Non-limiting examples of non-aqueous solvent-based liquid ink compositions include as a carrier, or solvent, ethylene glycol butyl ether acetate (EGBEA), cyclohexanone, dipropylene glycol methyl ether (DPM), and/or diethylene glycol.

Non-aqueous solvent-based liquid ink compositions exhibit chemical and physical properties such as high volatility and a typical medium range surface tension. These physical properties requirements make the non-aqueous solvent-based liquid ink composition more compatible with the preferred wetting composition discussed hereinabove, and therefore using such ink compositions can afford images of overall higher quality.

Thus, according to a preferred embodiment of the present invention, the liquid ink compositions are non-aqueous solvent-based ink compositions.

The presently most preferred liquid ink composition includes as the carrier ethylene glycol butyl ether acetate.

The liquid ink composition used in the process described herein may further include one or more agents such as, for example, adhesion promoting agents, as described hereinabove, which are aimed at improving properties of the resulting image such as durability, and/or provide the ink composition with characteristics that would beneficially affect its interaction with the wetting composition (e.g., enhanced or reduced surface tension and/or viscosity), as is discussed in detail hereinabove.

The concentration of such agents in the liquid ink composition, according to this embodiment of the present invention, preferably ranges from about 0.01 weight percentage to about 75 weight percentage of the total weight of the liquid ink composition, more preferably from about 0.1 weight percentages to about 50 weight percentages of the total weight of the ink composition and more preferably from about 0.1 weight percentages to about 10 weight percentages of the total weight of the ink composition.

The agents described above can therefore be added, according to the present invention, to either one or both of the wetting composition and the ink composition. Furthermore, these agents can be applied on the area on the image subsequently to the application of the liquid ink compositions either before or after the curing step. Applying, for example, an adhesion promoting agent on the printed image before the curing can be performed in order to enhance the wash-fastness of the colorants and provide mechanical and chemical protection to the printed image.

The printing process of the present invention thus produces images with improved resolution, definition and brightness, as compared with the presently known printing technologies, and is particularly useful for printing multicolor images on absorptive and other surfaces. As is demonstrated in the Examples section that follows, by contacting the surface, prior to the formation of the image, with a suitable wetting composition, the feathering and bleeding of the ink dots one into the other is substantially reduced, the ink droplets exhibit a tight and symmetrical droplet shape when applied onto the wetted surface, higher optical density of ink on the surface is achieved (allowing printing of higher-resolution images), and the ink does not infiltrate to the back side of the surface. The use of a volatile solvent in the wetting composition allows for complete or substantially complete removal thereof, as is shown by the absence of noticeable traces of the wetting composition after the image is cured.

In summary, the images produced by the process of the present invention, are characterized by minimized ink absorption into the surface (e.g., minimized diffusion of ink to the back side of a thick layered surface); high and long-lasting color vividness; high resolution; and high durability.

The process described hereinabove can be performed on any desirable surface, using an appropriate printing machine. Thus, the surface can be a flat surface and a non-flat surface such as a curved surface or any uneven surface.

Further, the surface can be in a form of e.g., a film, a foil, a sheet or any other face of any three-dimensional object.

As is discussed in detail hereinabove, the process according to the present invention is particularly beneficial when the surface onto which the image is printed has undesirable characteristics that reduce the image quality. These characteristics include, for example, absorptiveness and high surface tension as compared with that of the ink, which lead to smearing of the ink composition and hence to reduced brightness and resolution.

Thus, the process according to the present invention is particularly beneficial when the surface is made of an absorptive material such as fibrous material and a porous material or a material characterized by high surface tension. Examples of such surfaces include, without limitation, textile fabrics, plastics, metals, glass, wood and rock.

The surface described above may form a part of a subject that is made of the same material or, alternatively, include one or more additional layers such as, for example, a paper layer, a foam layer, a textile fabric layer, a natural or synthetic rubber layer, a ceramic or glass layer, a resin layer and the likes, and any combination thereof.

As is further discussed in detail hereinabove, the process according to the present invention is particularly useful when the surface includes one or more fibrous materials, e.g., a textile fabric.

Textile fabrics that are suitable for use in the context of the present invention include, for example, woven fabrics, knitted fabrics, and non-woven fabrics such as felt fabrics.

The textile fabrics, according to the present invention, may include fibers from any animal, plant and/or synthetic source such as, for example, wool, silk, cotton, linen, hemp, ramie, jute, acetate, acrylic fabric, lastex, nylon, polyester, rayon, viscose, spandex, metallic composite, carbon or carbonized composite, and any combination thereof.

The printing process of the present invention is highly suitable for garments made of one or more textile fabrics, and therefore one of the preferred embodiments of the present invention is the use of this novel printing process on a piece of garment. An exemplary garment is a cotton T-shirt.

As described and discussed hereinabove, the printing process of the present invention and its novel principles is suitable for a variety of combinations of printing techniques using liquid inks on absorptive and glossy surfaces. One example for a highly compatible printing technique, with respect to the present invention, is digital inkjet printing directly on the subject surface.

Hence, the present invention further relates to the combination of screen-printing and digital-printing on various substrates providing accurate, high quality, high resolution, multi-color printing directly onto a substrate in a relatively simple system.

A preferred embodiment of the present invention is useful for printing over materials that usually cause the ink to feather in the material of the surface, such as fibrous materials, porous materials and other ink absorbing materials, and materials having high surface tension with the ink liquid. A preferred embodiment of the present invention is thus provided for the garment industry in general, and for T-shirt printing industry in particular.

The printing system may optionally further include a garment handling assembly; and further optionally, at least one curing assembly, operative to cure the ink composition and/or the wetting composition, and/or expedite the drying of the wetting composition. Even further optionally, the printing system includes at least one ironing assembly, operative to iron the garment prior to printing or wetting.

The wetting assembly preferably comprises one or more units capable of applying liquid over selected areas of the surface to be printed. Such units can be, for example, spraying nozzles, dripping nozzles, droplet injectors, drop-on-demand piezoelectric inkjet nozzles, continuous piezoelectric inkjet nozzles, roller pads, stamping pads, offset printing, screen printing stencil, etc.

A preferred embodiment of a digital-printing apparatus according to the present invention typically comprises electronically controlled wetting and printing units such as spraying nozzles, dripping nozzles, droplet injectors, drop-on-demand piezoelectric inkjet nozzles, continuous piezoelectric inkjet nozzles, etc. that are capable of creating image pixels in a controllable manner.

Reference is now made to FIG. 7, which is a simplified perspective drawing of a garment printing apparatus 46 constructed and operative in accordance with another embodiment of the present invention. The garment printing apparatus 46 comprises the stencil-printing apparatus 24, a wetting apparatus 47 and the digital-printing apparatus 25. As can be seen in FIG. 7, the wetting apparatus 47 and the digital-printing apparatus 25 are hosted in two separate stations of the stencil-printing apparatus 24. Preferably, for each printed garment, the stencil-printing is executed first, then the wetting, and then the digital-printing.

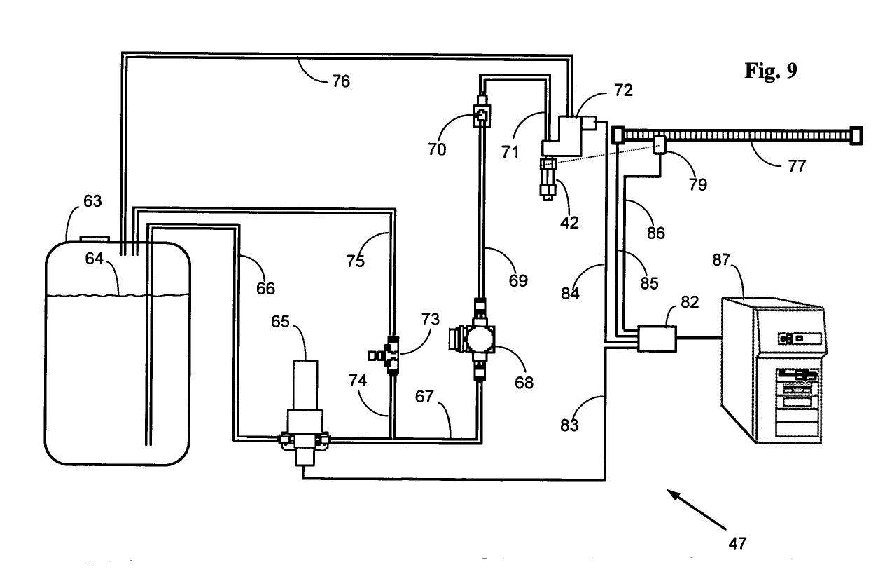

The wetting apparatus 47 preferably comprises a first part 48, preferably mounted on an upper beam 30 and a second part 49, preferably mobile on the floor and carrying the rest of the wetting apparatus 47 as is further described in accordance with FIGS. 9, 10 and 11 below. In another preferred embodiment of the present invention both parts of the wetting apparatus are mounted on a single mobile frame similar to frame 33 of the digital printing apparatus 25.

Alternatively, the wetting operation is performed using stencil-printing technology. Preferably a printing station 50 of the stencil-printing apparatus 24 performs the wetting. Preferably the wetting station 51 is the last station before the digital-printing station. Preferably the stencil-printing apparatus 24 is a screen-printing apparatus and the wetting station is a screen-printing station. Preferably the screen-wetting station employs screen printing ink, preferably transparent ink.

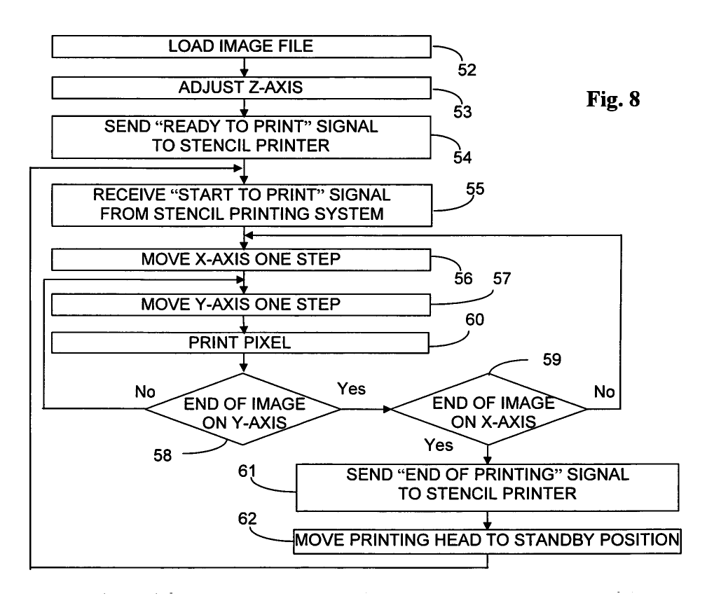

Reference is now made to FIG. 8, which is a simplified flow chart of the process of wetting the garment prior to printing, preferably executed by a computer controlling the operation of the digital printing apparatus 25. The printing process starts by loading the image to be printed from the computer's storage to the computer's memory (element 52 of FIG. 8). The height of the printer head is then adjusted (element 53) and a “ready” signal is sent to the stencil printing apparatus 24 (element 54). When a “start printing” signal is received from the printing apparatus 24 (element 55), signaling that the printing head 28 has been rotated and positioned in place, the printing head starts scanning the garment (elements 56, 57, 58 and 59), printing pixel by pixel (element 60), until the complete image is printed. The computer then sends (element 61) an “end of printing” signal to the stencil printing apparatus 24, returns the printing head to the standby position (element 62) and waits for the stencil printing apparatus 24 to remove the current printing head and position the next printing head.

Reference is now made to FIG. 9, which is a schematic illustration of the wetting apparatus 47 constructed and operative in accordance with one embodiment of the present invention.

It is appreciated that wetting the garment prior to printing limits the penetration of the ink into the garment so that a larger amount of ink remains on the external, visual, layers of the fabric, and that the printing head is thereafter capable of creating smaller dots of ink. Therefore the printed image has a higher quality, through higher resolution and stronger colors.

In a preferred embodiment of the present invention the wetting assembly apparatus 47 comprises a tank 63 containing a wetting composition 64, a pump 65, such as MGC4-MGC11DC available from Fluid-o-Tech of 23 via Morimondo, Milan, Italy, connected to the tank 63 through a pipe 66 and operative to pump the wetting composition 64 from the tank 63 to the spraying nozzle 42, such as spraying nozzle model 1101, available form Teejet, PO Box 7900 Wheaton, Ill., USA, via a pipe 67, a pressure regulator 68, such as CM004R01, available from Camozzi, S.p.A. Via Eritrea 20/I, 25126 Brescia—Italy, a pipe 69, a manifold 70, a pipe 71 and a solenoid valve 72, such as FCN90221471 available from Flo Control, Germany. An overflow needle valve 73, such as GS0462216 available from Serto A.G., 25 Schutzenstr, CH-8355 Aadorf, Switzerland, is operative to carry excess wetting composition back to the tank 63 via pipes 74 and 75. A pipe 76 is also operative to carry overflow wetting composition from the solenoid valve 72 to the tank 73. Preferably, a plurality of solenoid valves 72 and spraying nozzles 42 are constructed to form a battery of spraying nozzles as will be described below. The spraying nozzles 42 are controllably mounted on an accurate linear motion axis 77 and the position of the spraying nozzle 42 is respect to the linear motion axis 78 is measured by a linear encoder 79. The pump 65, the solenoid valve 72, the linear motion axis 80 and the linear encoder 81 are preferably controlled by a programmable logic controller (PLC) 82, via wiring 83, 84, 85, 86 respectively.

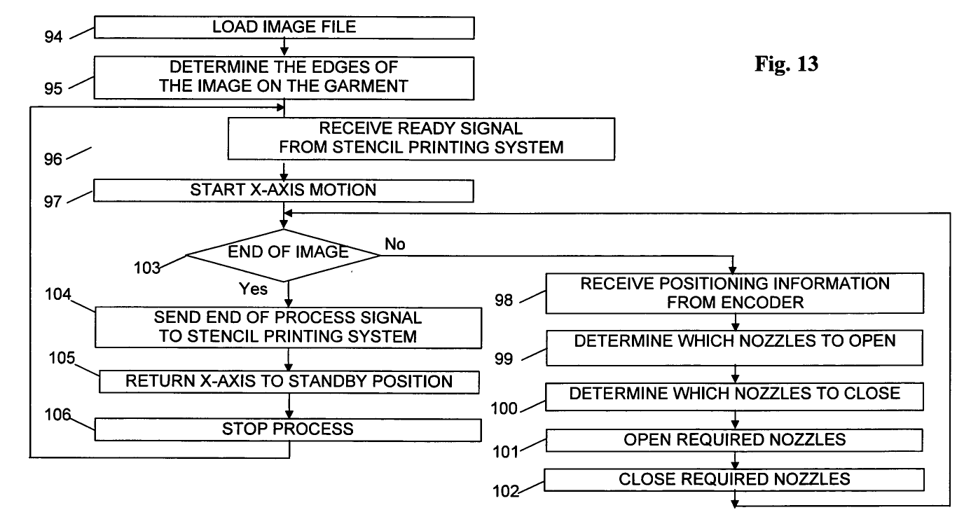

A computer 87, via the programmable logic controller 79, moves the spraying nozzle 42 by operating the linear motion axis 88, measures the position of the spraying nozzle 42 the linear encoders 89, activates the pump 65, and then the solenoid valve 72, to inject streams of the wetting composition 64, preferably to selected areas of the printed object, preferably the printed object is placed on the rotating printing table 28 of the printing apparatus 23. In a preferred embodiment of the present invention, the role of the PLC 82 is to translate the commands effected by the computer 87 into electrical activation to the relevant components. A detailed description of the computer 87 procedure to operate the wetting apparatus 48 is further shown and described below with reference to FIG. 13.

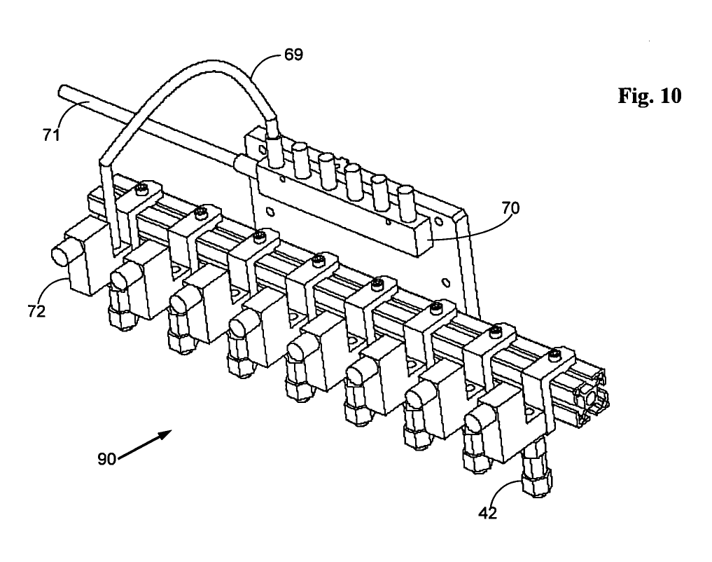

Reference is now made to FIG. 10, which is a perspective drawing of a battery 90 of solenoid valves 72 and spraying nozzles 42, constructed and operative in accordance with one embodiment of the present invention. The solenoid valves 72 are each connected via the pipe 69, the manifold 70 and the pipe 71 to the pressure regulator 68 (not shown in this figure).

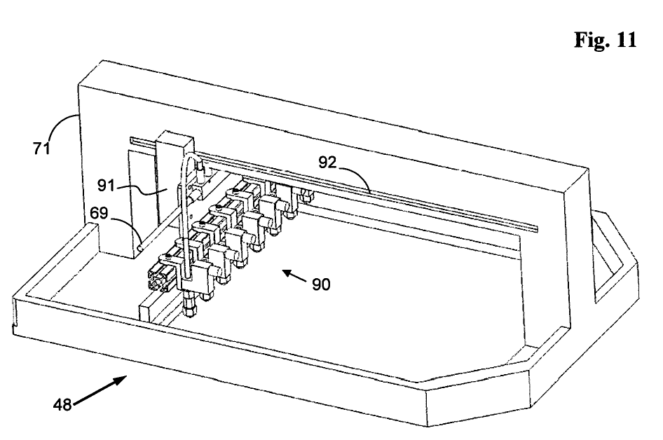

Reference is now made to FIG. 11, which is a perspective drawing of the first part 48, of the wetting assembly 47, constructed and operative in accordance with one embodiment of the present invention. The first part 48 preferably comprises a battery 90, mounted on a U-shaped bridge 91, mounted on an accurate linear motion axis 92. such as accurate linear motion axis 77 of FIG. 9. The pipes 69 and 76 (not shown) and the electrical wiring 84, 85 and 86 (not shown), all described in FIG. 9, connect the first part 48 to the second part 49 of the wetting apparatus 47.

It is appreciated that the battery 90 can be alternatively mounted on the bridge 37 of FIG. 5, preferably at the other side of the bridge, opposite to the printing head 34.

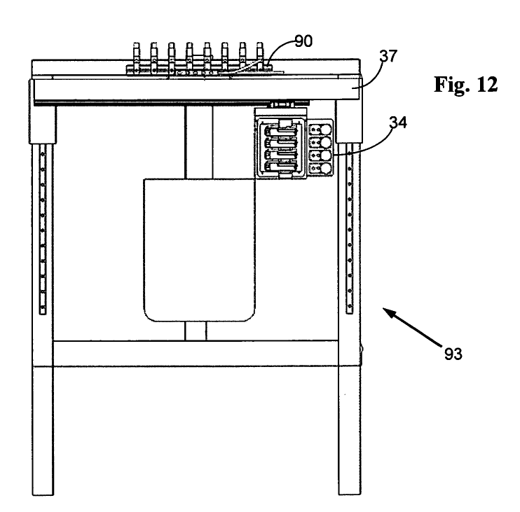

Reference is now made to FIG. 12, which is a simplified perspective drawing of a digital wetting and printing apparatus 93 constructed and operative in accordance with still another preferred embodiment of the present invention. The digital wetting and printing apparatus 93 is a combination of the digital-printing apparatus 25 shown and discussed in accordance to FIG. 5, and the wetting apparatus 47 shown and discussed in accordance to FIG. 9. As can be seen in FIG. 12, the wetting battery 90 is preferably mounted on the bridge 37 of the digital wetting and printing apparatus 93, preferably on the other side of the printing head 34.

Reference is now made to FIG. 13, which is a simplified flow chart of the process of wetting the garment prior to printing, preferably executed by the computer 87. The process of wetting the garment starts with element 94 by loading the image file from the computer's storage. The process progresses to element 95 to determine the edges of the image on the garment, which are also the edges of the area to be wetted. The process continues to element 96 and waits for a signal from the stencil printing system 24 that a printing table has been rotated and placed in position and is ready for wetting. The process proceeds to step 97 to activate the axis 36, which moves the battery 90. The process advances to element 98 to receive from the encoder the position data of the battery 90. The process proceeds to element to determine which nozzles to open (element 99) or close (element 100) and sends the appropriate commands (elements 101 and 102) to the nozzle solenoids 72, preferably via the PLC 82. When the other edge of the image is reached (element 103) the computer 87 sends a signal (element 104) to the stencil printing system 24 that wetting procedure is completed, returns the wetting head to the standby position 105 and the process is stopped (element 106).

It is appreciated that the method and the apparatus for wetting the garment can be alternatively used to coat any other surface that is capable of absorbing the ink, or that has a relatively high surface tension with the ink liquid, so as to limit the smearing of the ink through, or over, the surface.

It is also appreciated that the spraying nozzle 42 can be replaced by other means for applying liquid onto a surface, such as a dripping nozzle, a droplet injector, a drop-on-demand piezoelectric inkjet nozzle, a continuous piezoelectric inkjet nozzle, a roller pad, an offset printing stencil and a screen printing stencil.

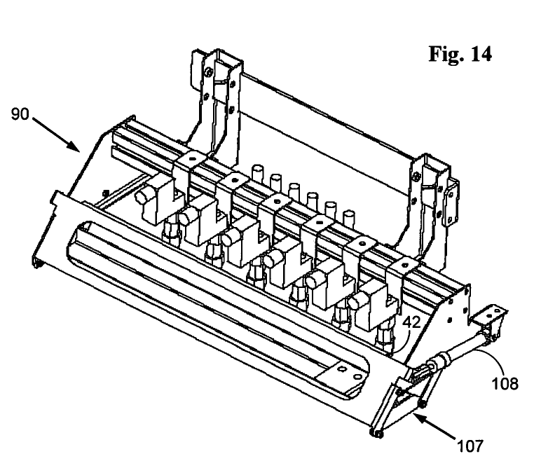

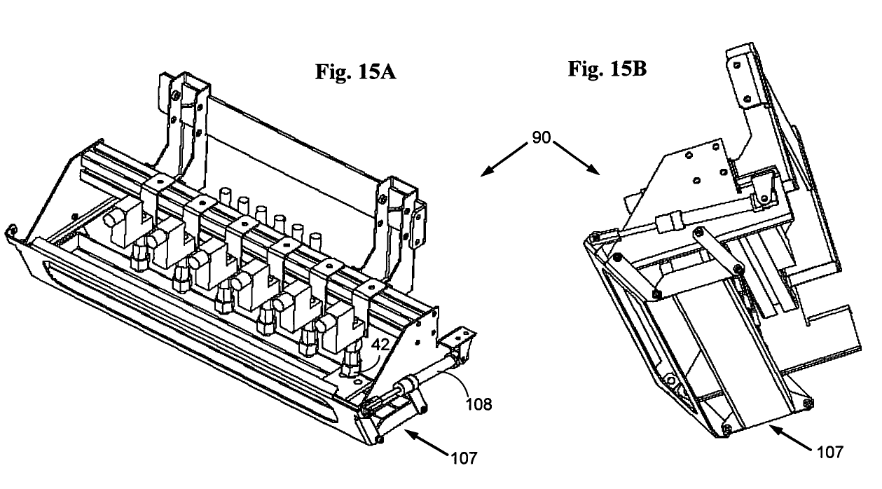

Reference is now made to FIG. 14, FIG. 15A and FIG. 15B, which are all simplified perspective drawings of a preferred embodiment of the battery 90 equipped with a bath 107, constructed and operative in accordance with one embodiment of the present invention. Bath 107 contains a thinner liquid, and is operative to dip the tips of the spraying nozzles 42 in this thinner liquid when the spraying nozzles are not spraying, as can be seen in FIG. 14. Before spraying is initiated, computer 87 activates a solenoid 108 to move the bath 107 and expose the tips of the spraying nozzles 42, as can be seen in FIGS. 15A and 15B. A similar bath apparatus is preferably available for the digital-printing head 34, to prevent drying of the ink within the inkjet nozzles.

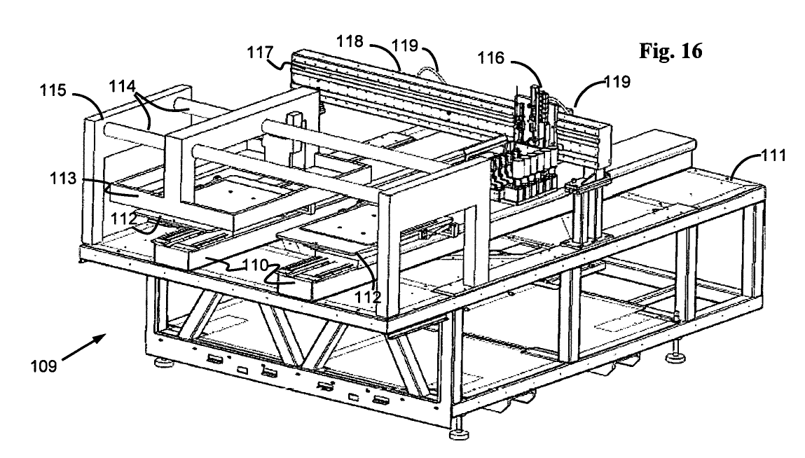

Reference is now made to FIG. 16, which is a simplified perspective drawing of a garment printing apparatus 109 constructed and operative in accordance with another embodiment of the present invention. The garment printing apparatus 109 is preferably a dual carriage stencil and digital printing apparatus. It is appreciated that the garment printing apparatus 109 may be designed with a single carriage. It is also appreciated that the garment printing apparatus 109 may be used to print objects other than garments with the necessary modifications to the printing tables.

The garment printing apparatus 109 comprises a stencil-printing apparatus, a digital-printing apparatus, optionally a wetting apparatus and a pair of X-axis stages 110 mounted on a rigid frame 111. A printing table 112 is mounted on each of the X-axis stages 110. A stencil-printing head 113 is preferably mounted on a first Y-axis 114, preferably mounted over a first bridge 115. A digital-printing head 116 is preferably mounted on a second Y-axis 117, preferably mounted over a second bridge 118. Preferably two wetting batteries 119 are preferably mounted on the other side of the second bridge 118. The two printing tables 112 are operative to move along the two X-axis 110 between the stencil-printing station (under the first bridge 115), the digital-printing station and the wetting station (at the two sides of the second bridge 118). The stencil-printing head 113 and the digital printing head 116 are operative to move on their respective Y-axis and print over the two printing tables 112. Preferably, for each printed garment, the stencil-printing is executed first, then the wetting, and then the digital-printing.

It is expected that during the life of this patent many relevant printing devices and systems will be developed and the scope of the terms herein, particularly of the terms “stencil-printing”, “digital-printing” and “wetting apparatus”, are intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-71. (canceled)

72. A printing apparatus comprising:
a plurality of print stations for applying printing to textile media, said print stations being arranged about a circumference, and
a carousel for rotating about said circumference to carry said textile media for printing about said print stations,
and wherein at least one of said print stations is a digital-type printing station.

73. The printing apparatus of claim 65, wherein all of said print stations are digital type printing stations.

74. A ceramic printing system for printing on a ceramic surface comprising:
a stencil ceramic printing system, and
a digital ceramic printing system, and
said digital and said stencil ceramic systems being operatively combined for jointly printing said ceramic surface.
